(19) United States
(12) Patent Application Publication
(10) Pub. No.: US 2002/0046089 A1
(43) Pub. Date: Apr. 18, 2002

(54) Targeted advertising brochure and method for its use

(76) Inventor: Richard C. Zorn, Rivervale, NJ (US)

Correspondence Address: NIXON & VANDERHYE P.C., 8th Floor, 1100 North Glebe Rd., Arlington, VA, 22201-4714, US

(21) Appl. No.: 09/747,950

(22) Filed: Dec. 27, 2000

Related U.S. Application Data
(63) Continuation-in-part of application No. 09/497,180, filed on Feb. 3, 2000.
Application No. 09/497,180 is a division of application No. 09/074,461, filed on May 8, 1998.

(51) Int. Cl. G06F 17/60; B42B 2/00; B42B 2/02; B65H 5/30; B65H 39/00; B65H 39/02; B65H 41/00; G09F 1/00

(52) U.S. Cl. 705/14; 283/56; 270/52.19

(57) ABSTRACT

An advertising or promotional brochure is disclosed that is to be mailed in conjunction with a magazine or periodical. The brochure may include high-quality, glossy photographs, and be personalized with text and/or images that relate specifically to the magazine subscriber. Different versions of the brochure may be targeted to and mailed to different groups of subscribers. In addition, the brochure may include coupons for sales discounts, bank promotional checks, and other promotions that may be redeemed by the magazine subscriber. The brochure may be embodied as a multi-page pamphlet and may have an appearance and cover similar to the magazine to which it is attached.

### CONTINUING APPLICATION

This application is a continuation in part (CIP) of commonly owned and co-pending U.S. Pat. No. ______ (U.S. Pat. application Ser. No. 09/497,180, filed Feb. 3, 2000 (atty. dkt. No. 263-2251), which is a divisional application of U.S. Pat. No. 6,129,346, issued Oct. 10, 2000. The contents of these related patents and applications are incorporated herein by reference.

### FIELD OF THE INVENTION

The present invention relates to the fields of targeted advertising, promotional brochures and periodical subscription management. In particular, the invention relates to advertising and promotional materials to periodicals that are targeted to particular subscribers of the periodical.

### BACKGROUND OF THE INVENTION

Advertising and promotional inserts are well known for magazines and other types of periodicals. These inserts may be as simple as a postcard insert that is placed between two pages of a magazine, and is not attached to the magazine. These postcard inserts routinely fall out from between the magazine pages, when the magazine is opened. Another type of insert is an attached postcard that is secured to the magazine by, for example, the center staples used to bind the pages of the magazine. A multi-ply advertising insert for a magazine where the insert forms a pocket for a return brochure is described in U.S. Pat. No. 5,269,563. Other promotional inserts that have been included with magazines are product inserts, such as sample products of toothpaste, computer software CDROMS, and other small samples, that are included within a the pages of the magazine or enclosed within the plastic wrapper for the magazine.

An advantage of advertising inserts in a magazine or periodical is that there is no postage cost for the insert itself. The mailing cost is only that associated with mailing the magazine. There is no additional postage cost due to the advertising insert. The cost of mailing advertising and promotional materials (not included with a magazine) usually represents a substantial portion of the costs associated with those materials. Even when advertising and promotional materials are sent at bulk mail rates, the postage costs are substantial to separately mail advertisements and promotions. Inserting advertising and promotional materials in magazines is one technique used to avoid (or at least lessen) the costs of mailing advertisements and promotions.

Prior advertising and promotional inserts for magazines have not been effective as other types of brochures. These inserts tend to be small and provide limited information, in contrast to separately mailed, high-quality brochures and catalogs that include glossy photographs and detailed descriptions of products and services. The inserts are in stark contrast to the color photographs and extensive written text materials provided on the advertisements and articles on the pages of the magazines that include the inserts. A long-felt need exists for high-quality advertising inserts and attachments for magazines that are personalized to the subscriber, utilize promotions to entice magazine subscribers to purchase the product or use the service being advertised or effectively utilize the free postage associated with mailing the advertisement with the magazine.

A further disadvantage of conventional advertising inserts for magazines is that they are not sufficiently targeted to specific subscribers, and the interests of those specific subscribers. In particular, the advertising inserts are not selected for insertion in a particular magazine copy based on the type of subscriber who will receive the magazine with the insert. It is known to place the subscribers name and address on an advertising insert and to place advertising inserts that are relevant to a particular geographic area, e.g., an advertisement for a local store, in only those magazines to be mailed to that particular geographic area. However, the advertising inserts are not selected based on whether the magazine subscriber is or is not a customer of the business that sponsored the advertisement insert, and whether a non-customer subscriber is someone who is suitable to be a customer. With prior inserts, magazine subscribers all receive the same advertisement insert for a bank or credit card business, regardless of whether the subscribers are merely potential customers or current customers of the bank or credit card business. Accordingly, there is a need for techniques to target customers and prospective customers when using advertisement inserts to periodicals.

### SUMMARY OF THE INVENTION

An advertising or promotional brochure, e.g., such as Moore's promotional (sm), which is attached to a magazine, periodical, newspaper, or other publication (collectively a “periodical”) has been developed that may be mailed using U.S. Postal Service standard or periodical rates. The brochure is tailored to target particular types of subscribers of a periodical. The brochure may also be varied to better target different categories of subscribers of the periodical.

For example, a credit card brochure may include three brochure versions, each of which is tailored to one of: (i) subscribers who are existing credit card customers, (ii) potential new credit card customers with good credit, and (iii) potential new credit card customers with undetermined credit. A brochure version targeted to existing customers may provide a store discount coupon for use by the card customers with purchases paid with a credit card. The purpose of brochures targeted to existing customers promotes the use of a specific credit card by the subscriber.

A second brochure version is targeted to subscriber/potential customers with good credit and may include a coupon which both authorizes a credit card company to issue a new credit card to the customer and provides a discount for a store purchase or subscription renewal. This second brochure is an easy-to-use, pre-approved credit card application that allows a subscriber to quickly and simply activate a new credit card.

The third brochure version is targeted to subscriber/potential customers with undetermined credit, and may include a conventional credit card application form to be completed by those subscriber/potential customers who desire a new credit card. This third brochure provides a standard credit card application which requires a subscriber to enter personal financial information needed to perform a credit check on the subscriber. The application, when completed by the subscriber, is used by the credit card company to perform a credit check on the subscriber before the company approves the application and issues a credit card to the subscriber.

Using data mining technology, a novel system has been developed to select which brochure version to attached to each subscriber's periodical and print information, e.g., name and address, on the brochure that personalizes the selected brochure to the subscriber. Data mining is a computer processing technique of obtaining information from one or more computer databases by identifying relationships between the data stored in these databases. For example, a relationship of magazine subscribers and credit card customers may be used to obtain a list of all subscribers (from a magazine database) who also hold credit cards from a particular card issuer (using the issuing company's database). Using this list of subscribers/cardholders, brochures targeted to existing cardholders may be included in periodicals mailed to those subscribers, where the brochures promote the use of the credit card already held by the subscriber.

In addition, the brochure may include high-quality, glossy photographs, and be personalized with text and/or images. The brochure may further include coupons, such as for credit card activation, product and subscription price discounts, credit-card checks, rebates, etc. (collectively referred to as coupons) for sales discounts and other promotions that may be redeemed by the magazine subscriber. The brochure may be embodied as a multi-page pamphlet that has an appearance and cover similar to the cover of the magazine to which it is attached. Accordingly, the present brochure provides an advertising and promotional brochure that is as appealing to the magazine subscriber, as is the magazine itself. Indeed, the brochure may be applied to the front cover of the magazine and appear much like the front cover of the magazine.

The brochure is intended to effectively use the free postage for riders and other inserts to magazines and periodicals. In this regard, it may be preferable for the advertising brochure to have substantial portions, e.g., at least 25% of its page area, devoted to editorial and/or public service information to satisfy postage regulations for free postage. For example, the brochure may include a listing of emergency government telephone numbers which may be placed by the subscriber next to the subscriber's home telephone. A magazine-type layout for the brochure is well-suited to the presentation of editorial and public service information. Thus, magazine-type layouts are particularly suited for the brochures targeted to magazine subscribers.

The present brochure(s) solves a long-felt need for a high-quality, personalized magazine insert or attachment. The same high-quality photographs, graphics and text used in a magazine may also be used to create the layout of the present inventive brochures. In addition, the present brochures may include personalized information, such as the name and address of the magazine subscriber, and information related to the subscriber. It is believed that magazine subscribers are more likely to read and act on a promotional or advertising brochure that have been targeted to their specific interests (e.g., current card subscriber or credit worth, potential card applicant), than on other conventional magazine inserts.

A new method and arrangement of mining data has been developed related to magazine subscribers by using information regarding the subscriber, e.g., name, address and subscription payment history, to obtain information from other databases as to whether the subscriber is an existing customer of an advertiser, e.g., a credit card company, and (if not an existing customer) whether the subscriber is a good potential customer, e.g., has a good credit rating, is likely to purchase the advertised product (e.g., based on age, sex, marital status, income, and ages of children). These other databases may be databases maintained by the advertiser, e.g., a listing of existing customers, and/or other databases maintained by a credit reporting agency, or others. This new data mining technique allows advertisers to create sub-lists from a listing of periodical subscribers, where the sub-lists are of subscribers that are existing customers, pre-approved potential customers, potential customers for which approval will be required, and other sub-listings of specific groups of the subscribers to a particular periodical.

### BRIEF DESCRIPTION OF THE DRAWINGS

FIGS. 1A-1D are plan views of a front cover page and first and second interior pages, respectively, of an exemplary promotional brochure;

FIG. 2 shows the brochure shown in FIGS. 1A to 1D, attached to a magazine for mailing;

FIG. 3A, 3B and 3C are plan views of interior and exterior pages of a first version of an alternative promotional brochure targeted to non-approved, prospective credit card customers;

FIGS. 4A and 4B are plan views of interior pages of a second version of the alternative promotional brochure targeted to pre-approved prospective credit card customers;

FIGS. 5A, 5B and 5C are plan views of interior pages of a third version of the alternative promotional brochure targeted to existing credit card customers;

FIGS. 6A and 6B are computer program flow charts showing an exemplary computerized process for printing and assembling the brochures shown in FIGS. 1A to 1D; and FIG. 7 is a diagram of a computer network with access to various databases having information regarding magazine subscribers.

### DETAILED DESCRIPTION OF THE DRAWINGS

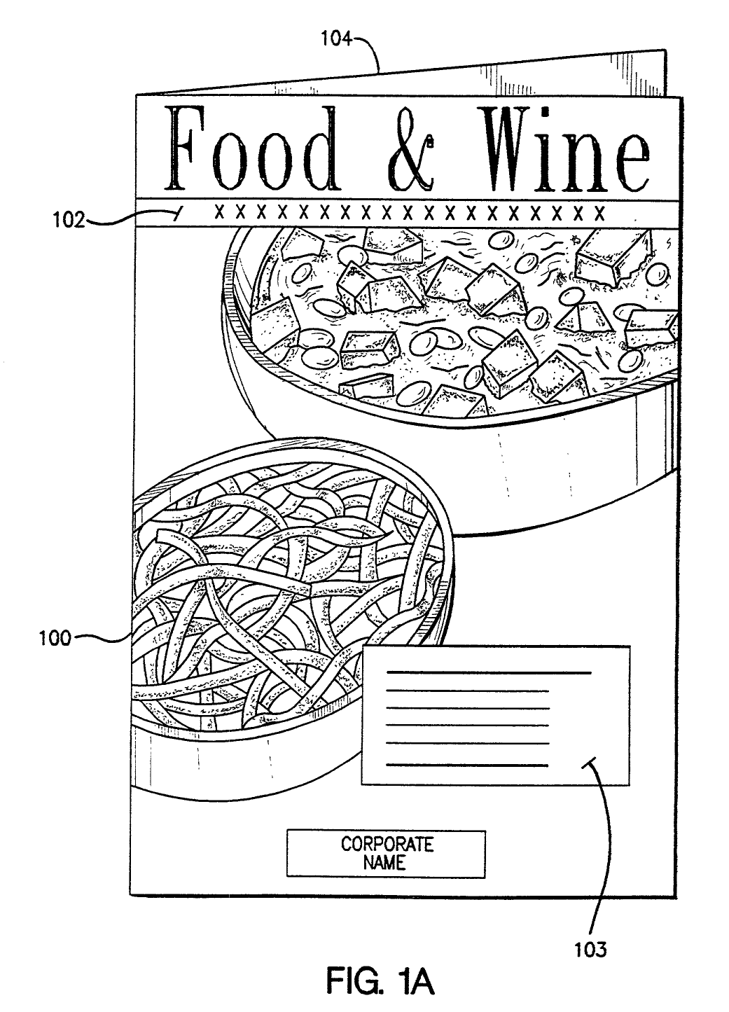

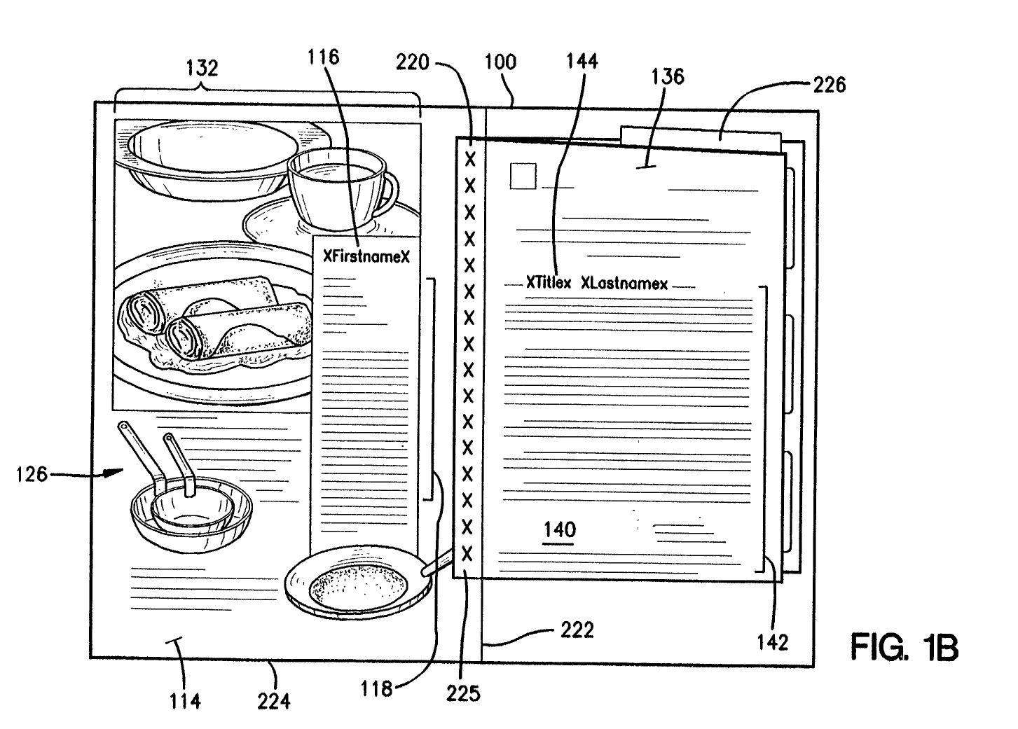

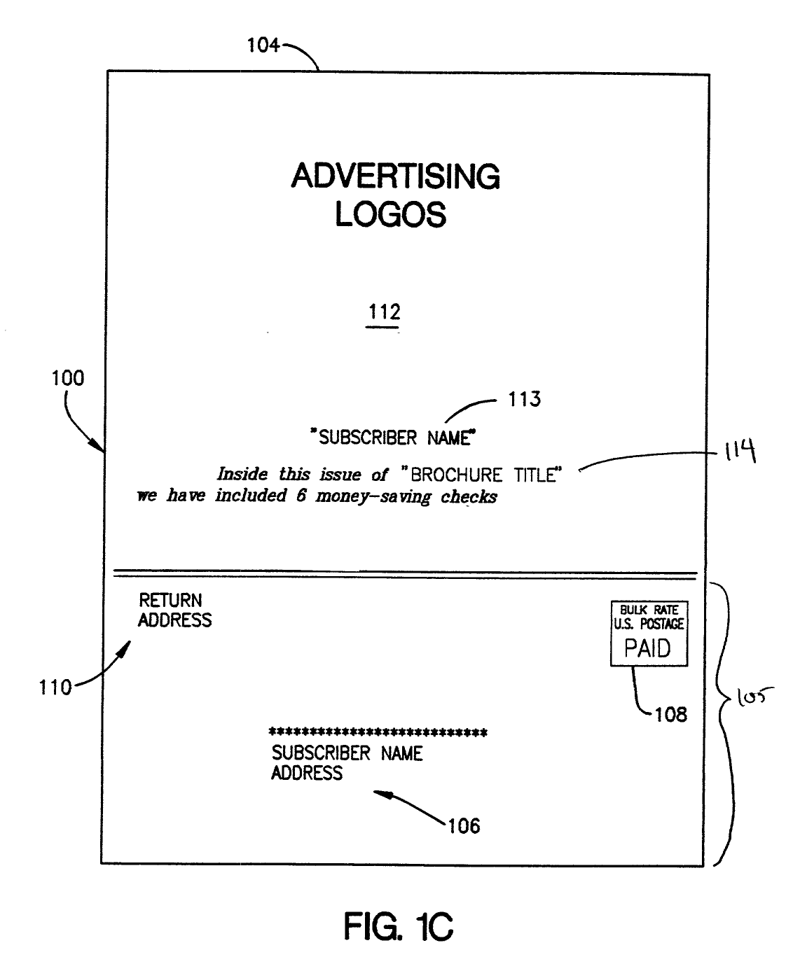

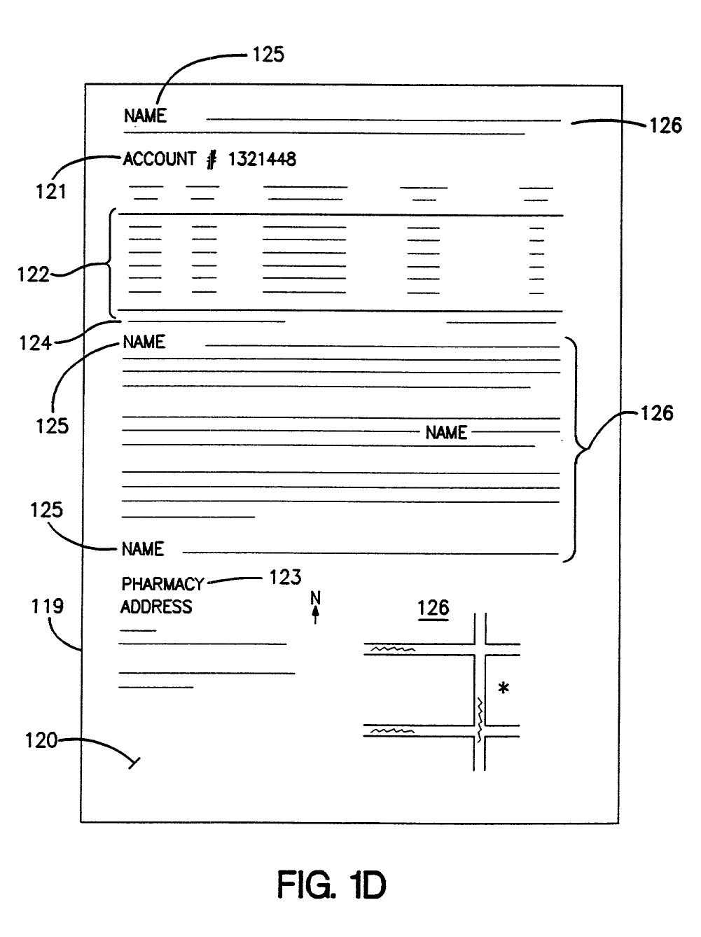

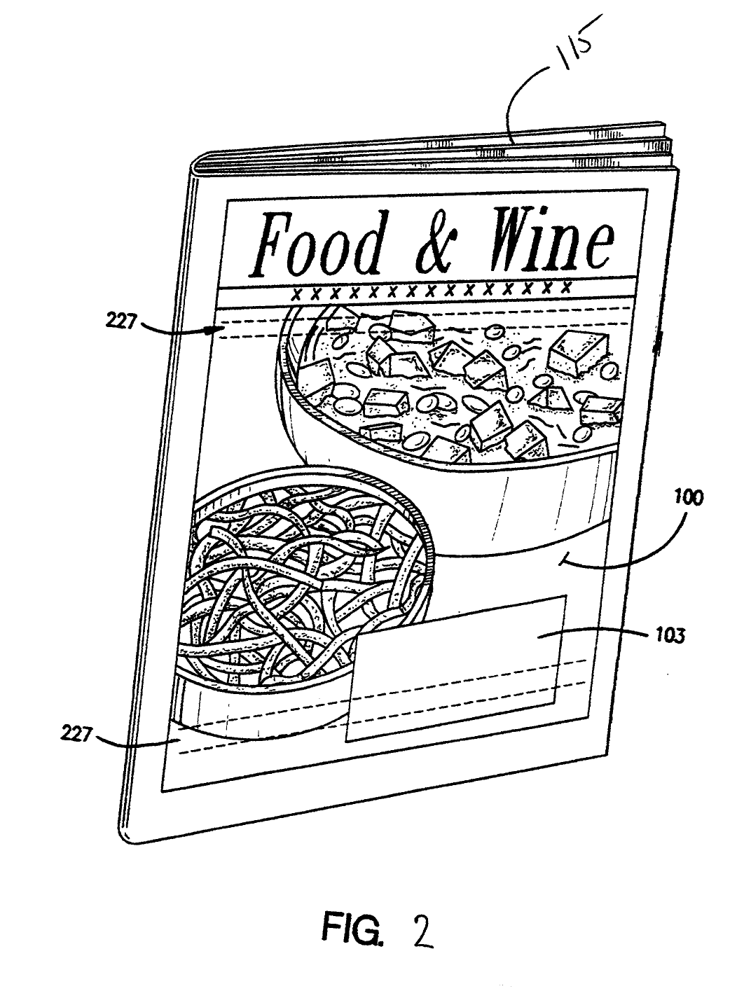

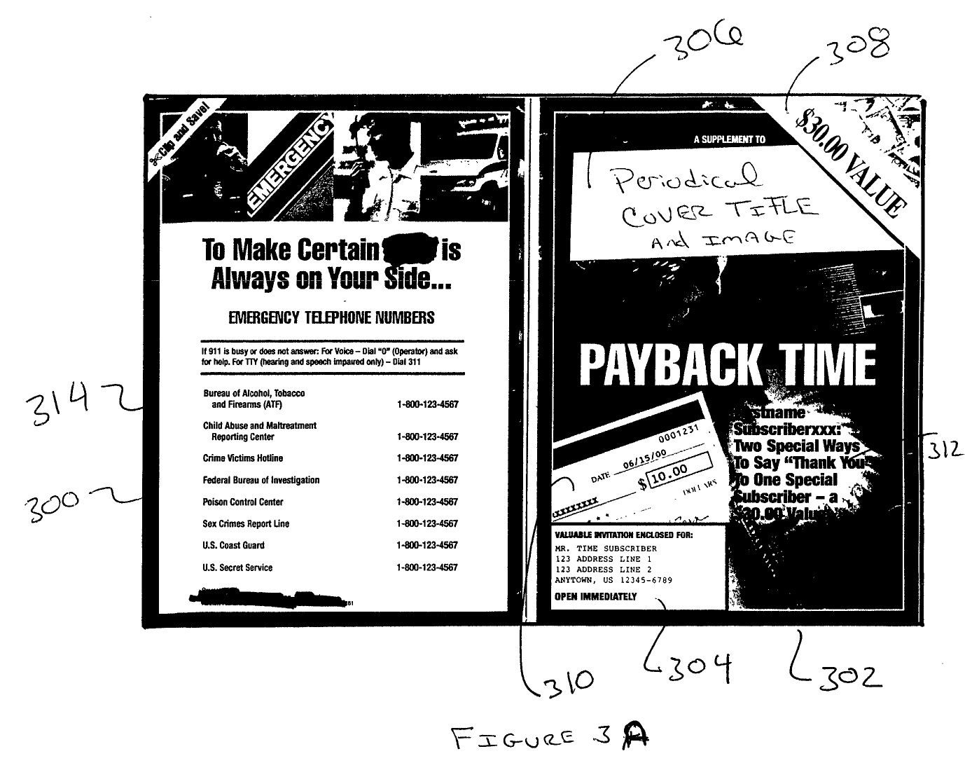

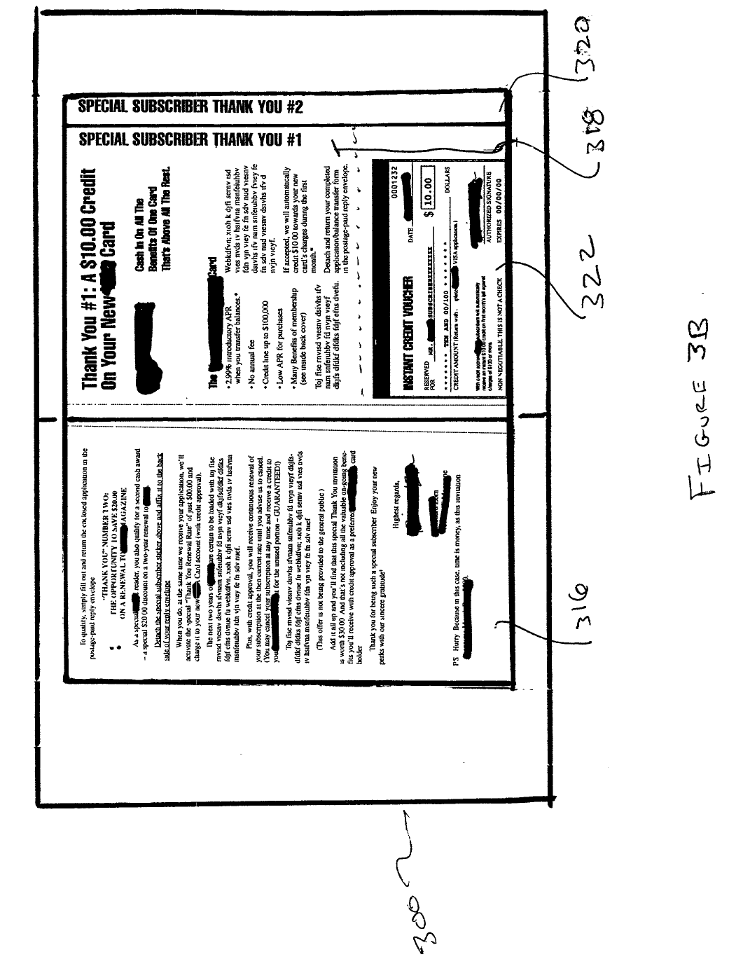

FIGS. 1A to 1D show an exemplary advertising and promotional brochure 100 to be attached to a periodical prior to mailing, as is shown in FIG. 2. The front cover page 102 of the brochure may, for example, have the appearance of the cover page of a magazine and include a variable print field 103 for the subscriber's name and address. The back cover page of the brochure 104, shown in FIG. 1C, may include a detachable return mailer envelope 105 having subscriber address section 106, an area for postage 108, a return address section 110. In addition, the back cover page may include a public service announcement area 112 for promotional and other information, such as a listing of emergency telephone numbers for posting next to the subscriber's home telephone. The advertisement area may also include variable print information, such as the subscriber's name 113, and a “teaser” sentence, e.g., “we have included 6 money-saving checks” 114.

The brochure is intended to be attached to a periodical 115 (FIG. 2), and is referred to as “attached mail” to the periodical. The back cover page 104 of the brochure is attached to the front or back cover page of the periodical. Attached mail is a supplement to a magazine that is mailed with the magazine. Under U.S. postal regulations, attached mail does not require additional postage and can be mailed with the magazine without incurring additional postage costs. The postage free feature of the brochure 100 provides a substantial cost advantage to the brochure over other times of mailed advertisements. The brochure 100 provides an effective marketing and promotional device, that can be mailed postage free along with a periodical 115 already being delivered to the intended recipient of the brochure.

A computer selection process can be run to select those persons who subscribe to a magazine to receive the brochure 100. An advertiser or promoter may target the brochure to an audience of magazine subscribers. Alternatively, a business may direct a brochure to its own customers, who also subscribe to a particular magazine. An exemplary criteria for selecting magazine subscribers to receive a brochure 100 may be that the subscribers have been customers of a particular business or members of an organization, or that the magazine subscribers are of a certain age, gender or live in a certain geographic region. The publisher sponsors the brochure and may coordinate with an advertiser or business that provides promotional, advertising, and informational material for the brochure.

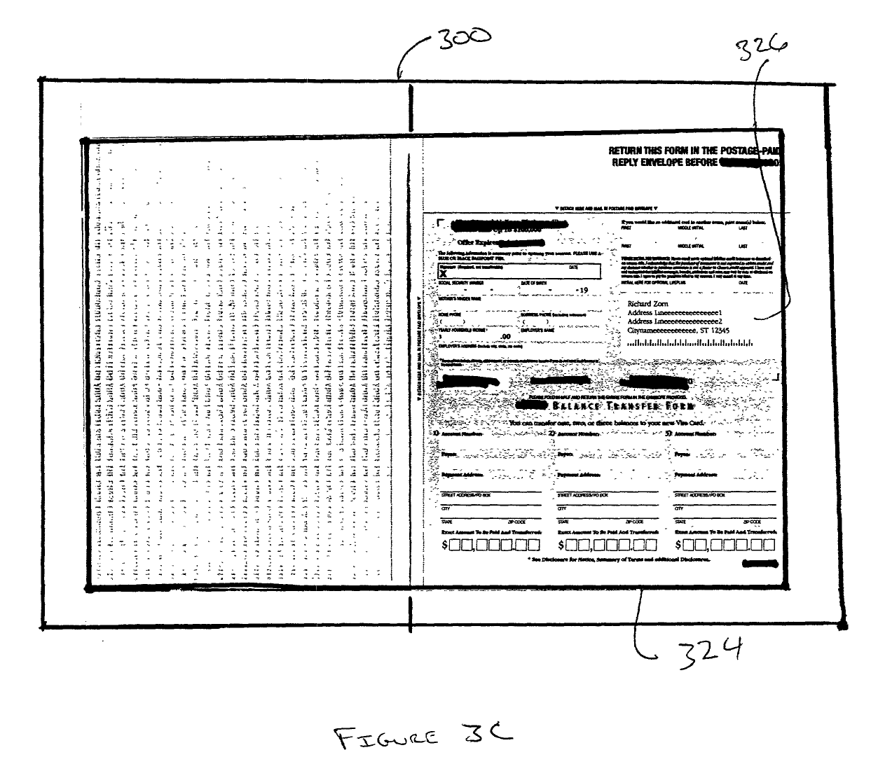

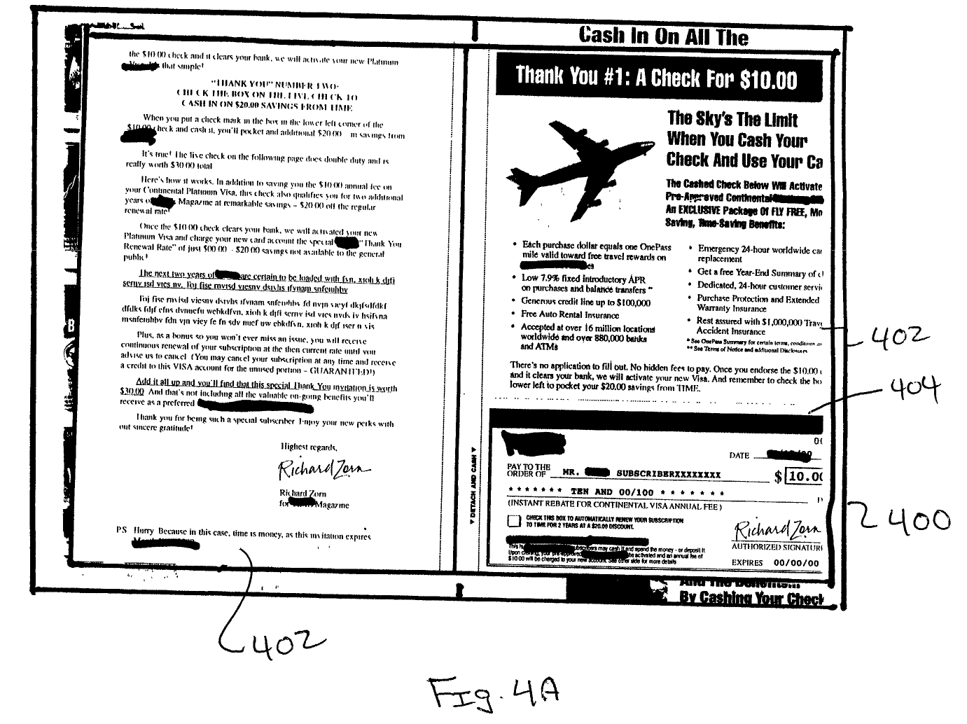

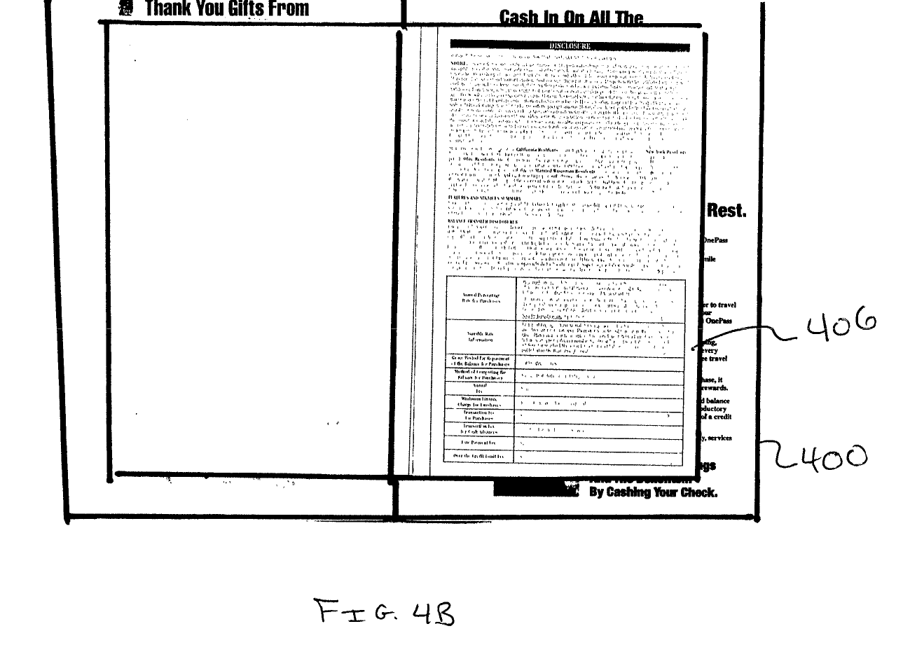

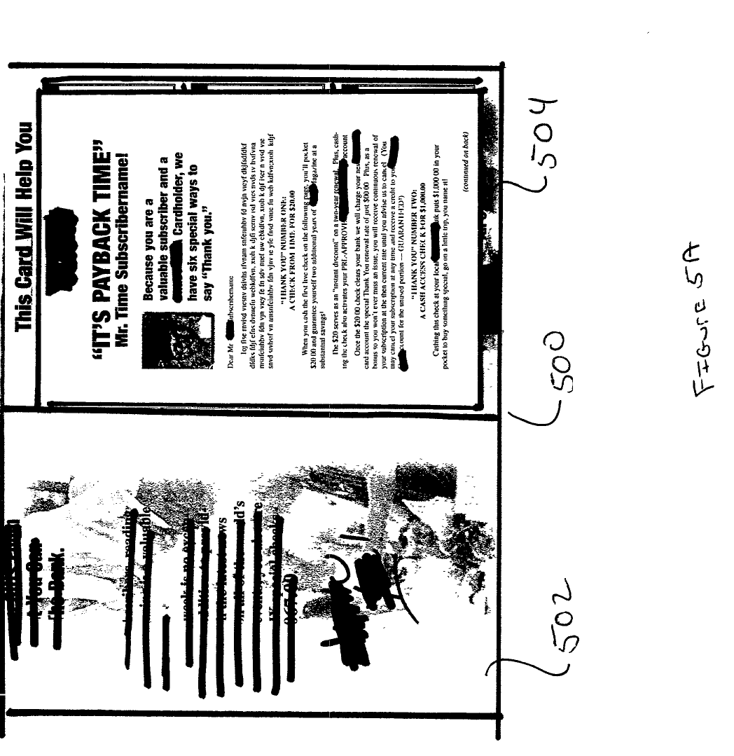

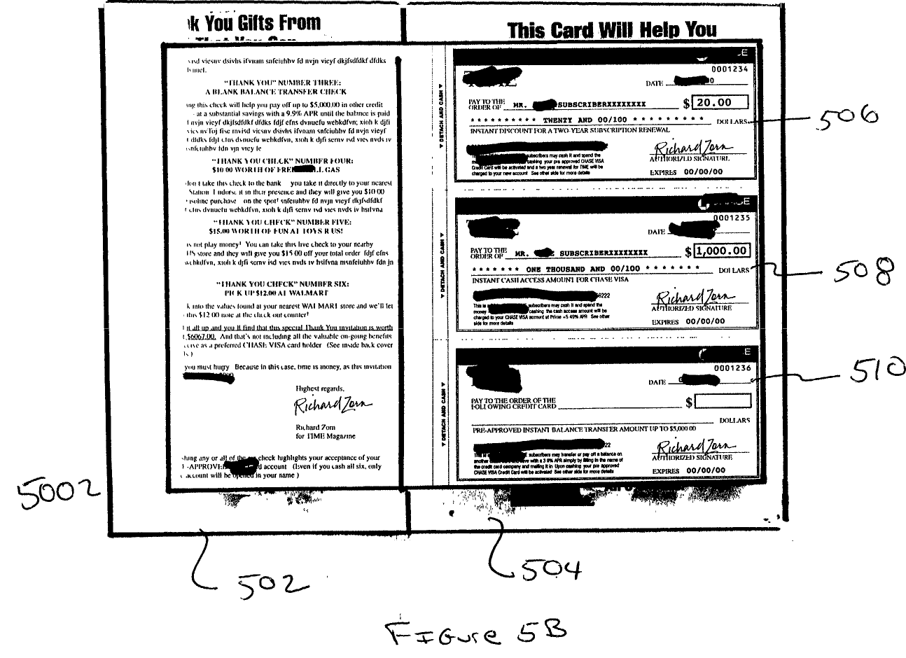

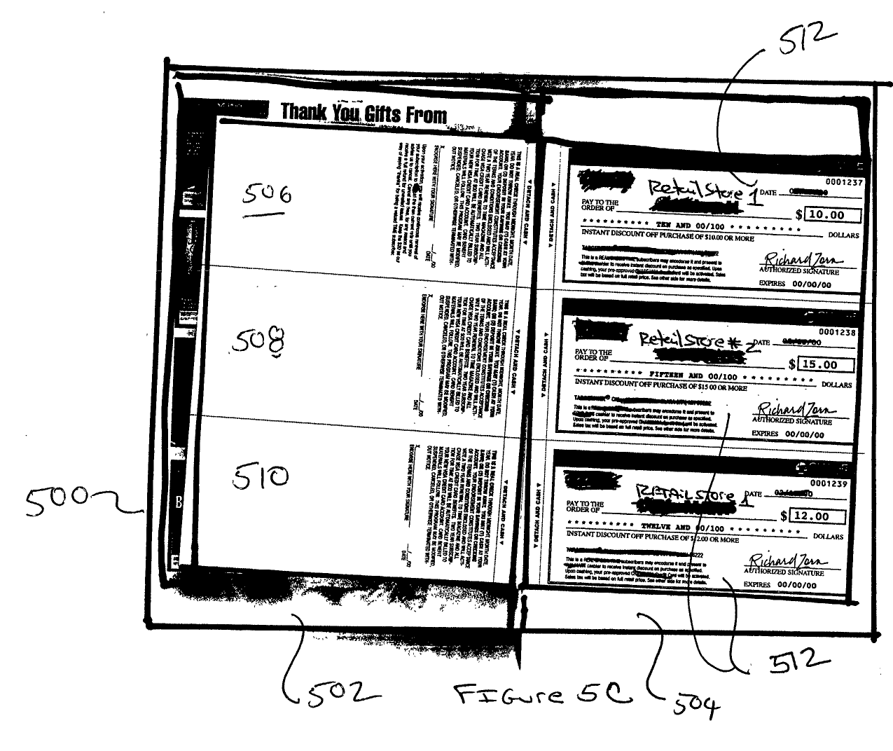

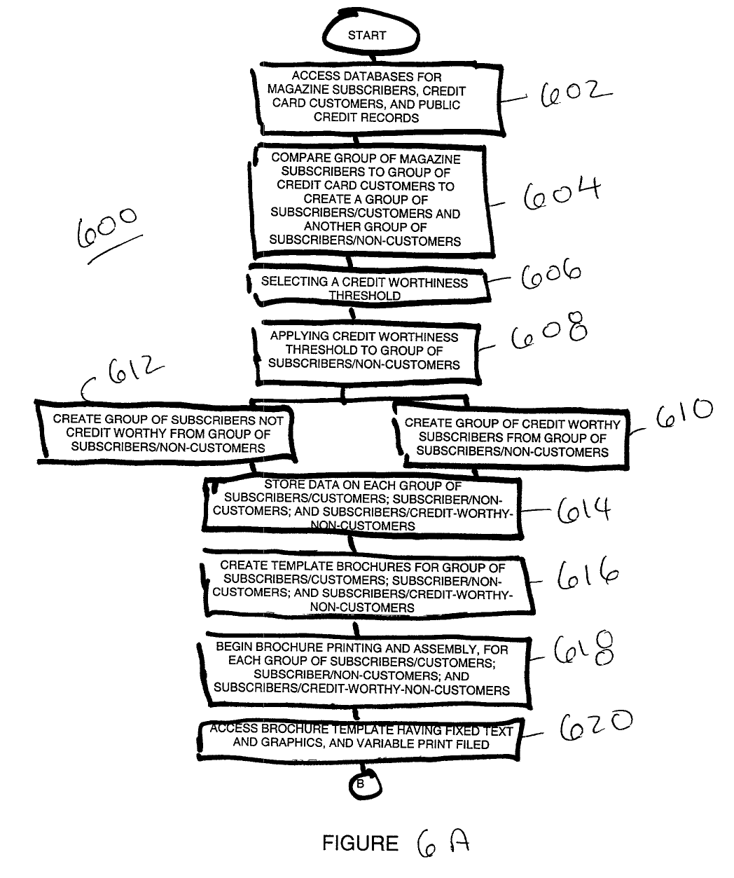

FIGS. 3A, 3B, 3C; FIGS. 4A and 4B, and FIGS. 5A and 5B show a sequence of three brochure versions 300, 400 and 500, which all relate to an exemplary promotional campaign by a credit card issuing company to solicit subscribers of a periodical to subscribe to its credit card services or to use its credit cards, if the subscriber is already a member. Brochure version 300 is targeted to subscribers of the periodical who do not hold a credit card from the credit card company, and whose credit history has not been previously evaluated to determine whether the customer is creditworthy. Brochure version 400 is targeted to subscribers of the periodical who do not hold credit cards from the issuing credit card company, and whose credit has already been determined to be good such they have been pre-approved to receive a credit card, if they so desire. Brochure 500 is targeted to magazine subscribers who already hold a credit card from the credit card sponsoring company.

Each brochure version 300, 400, 500, may be designed by a graphics artist, who may work on the advertising campaign to solicit new credit card customers for the credit card company sponsoring the brochures. The artist designs a brochure template for each brochure version. The template includes the static text, graphics and images that are included in every brochure of that version. The static portions of a brochure version are saved in an electronic file that is stored in memory 720 (FIG. 7) of a printer computer. The brochure templates also include variable print fields for variable text, graphics and/or images. These fields are blocked out on the brochure template to define the area of the brochure version to receive specific variable printing text, graphics or images. The variable print fields are each also linked to a field of a database that includes the variable text, graphics or images to be inserted in the print field as the brochure is being printed. For example, each brochure template may have a variable print field(s) for a subscriber's name and address. This field is linked to a subscriber database 702 that has the names and addresses for each subscriber of a periodical. As each brochure is being printed, the printer computer calls up the appropriate brochure template, e.g., the template for brochure 300, 400 or 500, and then calls up the variable data from databases to be inserted in the variable print fields of the template. The variable data may be unique to the subscriber to receive the brochure, e.g., the subscriber name and address, or may correspond to the promotion that is the subject of the brochure, e.g., text regarding the timing of the credit card offer, e.g., “this offer is open until November 31^{st}” or regarding particular retail stores that are identified on coupons included in the brochure. The print computer electronically combines the brochure template with the proper variable print data to provide the printer 726 with data and print instructions to print a particular brochure to be attached to a periodical.

FIGS. 3A, 3B and 3C show cover pages (FIG. 3A) and some of the interior pages (FIGS. 3B and 3C) of a brochure version 300 targeted to subscribers of the periodical, who do not hold a credit card from the card company sponsoring the brochure, and who have not been pre-approved to receive a credit card. The front and back covers of the other versions of the brochure 400, 500 may appear substantially the same as the cover of the first brochure version 300. The front cover 302 of the brochure 300 has a similar appearance to the front cover of the periodical. For example, the front cover of the brochure may include the title of the periodical 302, and graphics and text which are identical to that on the front cover of the periodical. In addition, the front cover 302 of the brochure may include an address label 304 used to mail both the periodical and the brochure to the subscriber. Moreover, the front cover of the brochure may include graphics and indicia unique to the brochure, such as a “teaser line” 308, e.g., “$30.00 value”. In addition, other graphics may be included on the front page 302, such as a partial image of a credit card or credit card check 310. There may also be text 312 which promotes the user to look at the brochure, e.g., “payback time”, and contains other text, e.g., “two special ways to thank you to one special subscriber—a $30.00 value” 312 used to entice the subscriber to open the brochure and read it. The back cover of the brochure 314 may include public safety information, such as a listing of emergency telephone numbers. This back cover 314 may be cut off from the other pages of the brochures, and placed by the subscriber next to the subscriber's telephone number for use in an emergency.

FIG. 3B shows three of the inside pages 316, 318, 320 of the brochure 300. On a first of these inside pages 316 is text explaining the advantages of accepting the credit card offer. On a second inside page 318 is the credit card offer itself, with an explanation of the details of the offer, and an “instant credit voucher” 322. This instant credit card voucher may be a credit amount, e.g., $10.00, to be used by the subscriber if and when the credit card application submitted by the subscriber is approved by the credit card company. The credit card voucher does not, by itself, activate the credit card or constitute a credit card application.

As shown in FIG. 3C, additional pages, e.g., 320, may be used to further explain the advantages of the credit card. A complete credit card application 324 may be included on another page of the brochure 300. This credit card application requests the subscriber to enter his name, address and certain financial information. The application, when completed and submitted to the credit card company, is used to evaluate the credit history of the applicant and for the credit card company to determine whether the applicant should be issued a credit card. The credit card application may include an address label having the name and address of the subscriber.

The address label 326 on the credit card application 324 may be used by the credit card company in reviewing applications to identify those applications which came from brochures attached to specific periodicals. Using this information, the credit card company can determine which brochures and which periodicals are the most successful in soliciting new credit card applications, and in particular new credit card applications which are approved and result in credit cards being issued to the applicant.

FIG. 4A and 4B show inside pages of a second version of the brochure 400 which is targeted to subscribers of a magazine, who do not hold a credit card with the sponsoring credit card company, but who have been pre-authorized to receive a credit card. The brochure 400 is similar on its cover pages to brochure 300, and has several similar inside pages, such as page 402 that describes the advantages of using the credit card and the credit card promotion. Brochure 400 includes a page 402 that describes a credit card offer and includes a credit card activation coupon 404. This coupon is signed (on its reverse side) by the credit card applicant, and submitted to the credit card company. The signal and submitted coupon 404 is the request by the subscriber to be issued a credit card. To entice the subscriber to submit the credit card request coupon 404, the coupon may include a dollar value, such as $10.00, to be applied towards some product or service, such as payment of the subscription fee for the periodical. Accordingly, brochure 400 provides an easy-to-use credit card application coupon 404, using this coupon, it is simple and easy for the subscriber to request a credit card from the credit card company. Brochure 400 may also include page 406 that is the “disclosure”of the terms and conditions of the credit card service offered by the credit card company. This disclosure statement is generally included with all new credit card applications and promotions, such as in brochures 300 and 400.

FIGS. 5A and 5B show inside pages of brochure 500. In particular, FIG. 5A shows the inside pages of the front 502 and back 504 covers of the brochure. This brochure 500 is directed to existing credit cardholders, and may include coupons 506 which provide a discount for renewal of the magazine subscription. In addition, coupons may be provided for a cash advance 508 on the credit card and a coupon may be provided which is a credit card check 510 which allows money to be transferred from one credit card to another, for example, to pay off credit card debt from another credit card. The brochure may also include discount coupons 512 which may be redeemed at various retail stores when purchases are made at those stores that are paid for using the credit card. Accordingly, the brochure 500 provides valuable coupons 506, 508, 510 and 512 which promote the use of the credit card by existing credit cardholders/subscribers.

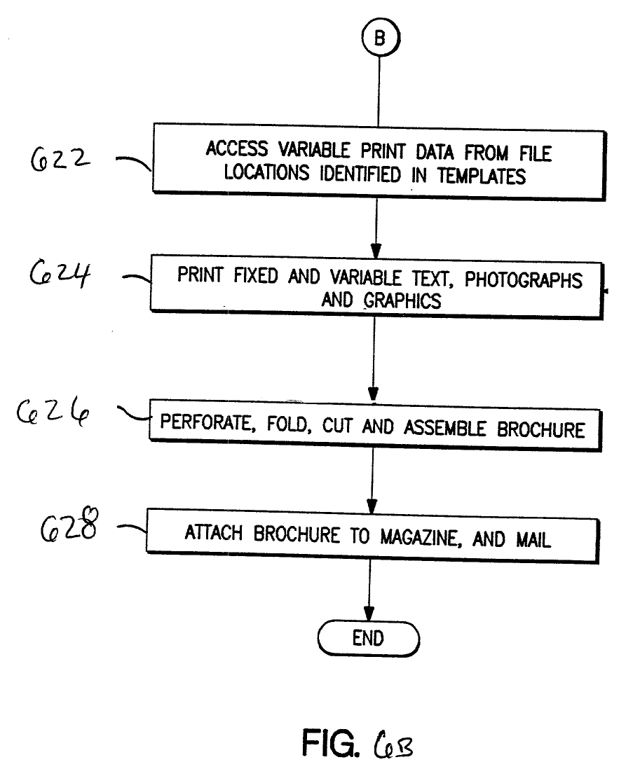

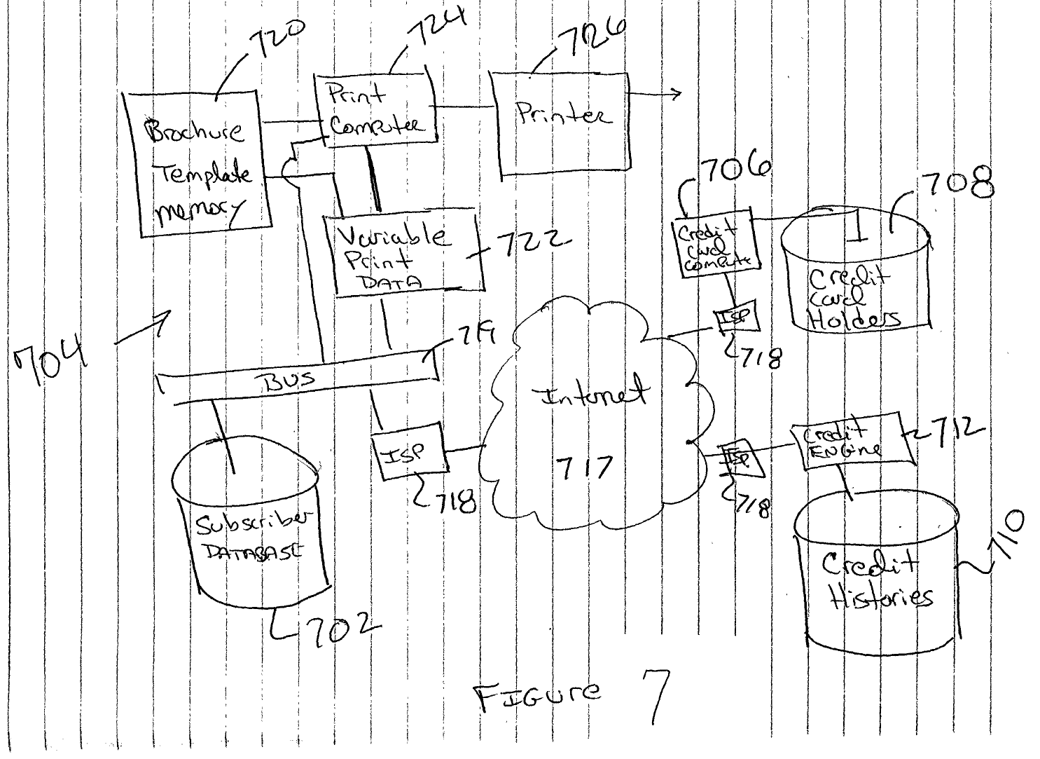

FIG. 6 is an exemplary computer flow chart 600 of a process for printing and assembling a brochure 100. A credit card company, for example, may distribute a brochure regarding credit cards by attaching the brochure to a periodical having subscribers that the credit card company wants to target as prospective customers. The credit card company may wish to target one version of its brochure to prospective card customers who have not been pre-approved; a second version of its brochure to prospective card customers who have been pre-approved, and a third version of the brochure to existing cardholders. To send each brochure version to its intended subscriber, sub-lists must be prepared from the list of periodical subscribers. The sub-lists may include those subscribers who (a) are not current credit cardholders and have not been pre-approved, (b) are not current credit cardholders, but whose credit history justifies pre-approval to be a credit cardholder, and (c) are current credit cardholders.

In step 602, various databases are identified and accessed. For example, a database 702 (FIG. 7) of information regarding the subscribers to the periodical may be accessed through the networked computer system 704 at the magazine publisher or printer. This subscriber database 702 may include the name and address regarding subscribers to the periodical. The database may also contain additional information about the subscribers, including their number of years at their mailing address, the number of years subscribing to the periodical, their payment history for subscription costs for the periodical, the number of individuals at the mailing address residence, and other information that the publisher of the periodical collects regarding the subscribers to the periodical. The data from the subscriber database will be used, in combination with other databases, to create sub-lists from the subscriber lists. These sub-lists are then married with one or more of the versions of the brochures to be attached to the periodical prior to mailing.

Other databases are also used to create the sub-lists. For example, a credit card company may sponsor the brochure to be attached to the periodical as a promotion for its credit card services. The computer system 706 of the credit card company may include a database 708 of persons holding credit cards issued by the company. The data stored in this database may include the name, address, credit limit, and other information about each credit cardholder.

By comparing, step 604, the names and/or addresses of the periodical subscribers obtained from the subscriber database 702, to the names and/or addresses of credit cardholder obtained from database 708, a first sub-list is generated of those subscribers who are credit cardholders, and a second sub-list is generated of those subscribers who are not credit cardholders. Further, sub-set lists of the list of subscribers/cardholders may also be generated, such as lists of those subscribers/cardholders who: have credit limits above (or below) some threshold limit, e.g., $5,000; have outstanding credit balances on their credit card account of above (or below) some amount, e.g., $3,000, and have not yet paid their next subscription fee for the periodical to which the credit card promotion is to be attached. This last sub-list requires a further comparison of information regarding subscription payments collected from the database of the magazine subscribers with the sub-list of subscribers/cardholders. Accordingly, the creation of sub-lists may involve multiple comparisons of data collected from different databases.

A list of pre-approved credit card clients may be prepared by the credit card company, and compared to a list of subscribers of a magazine. In step 606, a criteria is selected to be applied in determining whether a subscriber should be pre-approved to receive a credit card coupon brochure 400. The criteria will be dependent on the credit information available, for example, if the database 710 used to obtain credit information has data regarding the subscriber. The criteria for pre-approval may be that the subscriber has had the same residence for more than one year and/or has two or more credit accounts, e.g., credit cards or mortgages, and/or has no (or minimal) history of delinquent payments on the credit accounts, and/or has no history in the past three years of credit accounts being referred to collection agencies.

The criteria for selecting subscribers to be pre-approved for credit cards may be applied by a credit reporting agency, step 608, using a computer system 712. The credit reporting agency can compare the sub-list of subscribers/non-credit cardholders to its credit history database 710 to generate a further sub-list of subscribers/non-credit cardholders/good credit history, step 610. Brochures 400 will be sent to subscribers on this sub-list. A second sub-list, step 612, may be generated of those subscribers/non-credit cardholders that do not meet the credit criteria. Brochures 300 may or may not be sent to the subscribers on the list of those who do not satisfy the credit threshold criteria.

The databases and their respective computer systems communicate with each other. For example, the credit card computer system 706 and credit reporting computer system 716 each are linked to the Internet 717 via respective Internet service providers 718. The computer system(s) for the periodical and printer are also linked to the Internet. The desired data from the databases 702, 708, 710 can be collected to generate the various sub-lists of subscribers, in step 614. These sub-lists are then communicated to the printer computer via a network bus 719.

Once the lists of magazine subscribers to receive the various brochures 300, 400, 500 are compiled and stored, step 614, the process of printing and assembling the brochure is begun in step. Brochure templates are created in step 616. A different brochure template corresponds to each version of the brochure 300, 400, 500. A template has the fixed text, graphics and images of each brochure version. Each template may include the layout parameters of the brochure, such as page size; number of pages; fixed text, photographs and graphics, and blocked-out areas for variable text, photographs and graphics. A separate template may be used for each web substrate used to manufacture the brochure. Fixed text, photographs and graphics are those that are printed on every brochure and do not vary during a print run. Once the template for each brochure version has been created, the templates are electronically stored in memory 720 of the printer computer.

To begin the printing operation, a print computer 724 controls the printer 726 that prints the cover pages and interior pages of each brochure. Printer 726 may also include or be coupled to a document assembly system to collate the pages of the brochures and to attach the brochure to a periodical. In step 618, the computer selects a brochure template corresponding to the brochure version 300, 400 or 500, to be used for a particular subscriber. For example, the printer computer may generate brochures for an entire sub-list of subscribers, such as for the subscribers who do not hold credit cards and who have been pre-approved for a credit card. Once the brochures for the sub-list have been printed, the print computer 724 may then print brochures for another sub-list of subscribers. Alternatively, the print computer may sort the subscribers by address location, e.g., zip code, so that the brochures may be attached to periodicals in an order which facilitates mailing. Moreover, the print computer may sort the subscribers in any manner which is best suited to the printing operation and/or mailing operation. If the print computers sorts the subscribers in a manner other than based on the type of brochure version, then the print computer will be instructing the printer 726 to print brochures, where each successive brochure may be a different version brochure than the previously-printed brochure version. Because the brochure versions are stored in computer memory as “templates”, the print computer may easily switch between printing one brochure version to another by simply calling up from memory the appropriate brochure version corresponding to the subscriber whose subscriber information is to be printed onto the next-printed brochure.

The print computer selects, step 620, the appropriate brochure template and subscriber information to be printed with the template for each individual brochure being printed. For each subscriber, the print computer determines which brochure should be used for that subscriber by determining which sub-list the subscriber has been categorized in. If, by error, the subscriber is included in two or more sub-lists, then the print computer defaults to a lowest order brochure template of the sub-list in which the subscriber is included. The lowest order brochure template is predetermined by the sponsor of the brochures. For example, a credit card company may order the brochure templates such that the lowest order brochure is that which is given to subscribers who are not credit cardholders and who have not been pre-approved. The second lowest brochure template is that for non-subscribers who have been pre-approved for a credit card. The highest order brochure template is for existing cardholders. Accordingly, if a subscriber appears both on the sub-list for pre-approved for a credit card and not pre-approved for a credit card, then the brochure for that subscriber would be the brochure 300 for subscribers who have not been pre-approved for the credit card.

Variable text, photographs and graphics (collectively variable print data) are those that do vary from one printed brochure version to the next, in a single print run for a periodical. The variable text may be the address labels, subscriber name, and other such information. Because variable print data changes, a brochure template has variable print blocks on areas of the brochure to receive the variable printing 722, and may include a computer file name or database field that identifies the location in computer memory from which variable data is obtained during the print process, in step 622.

The address of the subscriber (addressee) is an example of variable print data that may be printed on the brochure 100, in step 624. The addressee section 106 back page 104 of the brochure, shown in FIG. 1C, is printed with the address of a subscriber to a magazine. The printed address of the subscriber may be used as the mailing address for the magazine. The addressee section 106 may also include alphanumeric information associated with the magazine, such as the subscription number, or associated with the business publishing the brochure, such as a customer number. Furthermore, the addressee section may include bar codes and other machine-readable information to facilitate the distribution, collating and mail handling of the brochure and magazine. By attaching the brochure to the magazine such that the addressee section is exposed and readily viewable by mail sorting equipment and mail delivery persons, the address on the brochure 100 may be used to direct the magazine to the proper address. Accordingly, the cost of applying an address directly to a magazine is avoided, if the addressee section 106 of the brochure is used as the mailing address for the magazine.

The inside pages of the brochure, shown in FIG. 1B, may include text, graphics, pictures, return mailers, coupons, other inserts, and other materials and information associated with the message to be conveyed by the brochure. For example, a first inside page 114 may include personalized information related to the addressee. The name of the addressee 116 may be printed at various positions in the brochure, in addition to the addressee section on the back cove. The template may include a database field code, e.g., “xfirstnamex”, to identify a database field having the subscriber's first name. The first and/or last name 116 of the addressee may be inserted into fixed text 118 on an inside page, e.g., 114, of the brochure. By placing the first and/or last name of the addressee in fixed text, the text becomes personalized to the magazine subscriber. The subscriber is more likely to read the text of the brochure and to be more receptive to the message of the brochure, because his name in interspersed in the text of the brochure.

The inside pages may also include fixed text and graphics, or variable text and/or graphics selected for each addressee during the print process. The fixed text 126 and fixed graphics 132 may be public service and/or editorial information, such as one would typically find in a magazine. It is preferable for twenty-five (25%) percent or more of the brochure is public service and/or editorial information. U.S. Postal regulations require that magazine attachments include 25% or more public service and/or editorial information to qualify for the free postage, when attached to a magazine or other periodical. A brochure that has less than 25% of editorial and public service information would require additional postage to be mailed with the magazine. To comply with the 25% minimum requirement, the editorial or public service copy can be interspersed throughout the brochure. For example, one of the four pages of the brochure may be devoted to public service and editorial information to qualify for free postage, when the brochure 100, 119 is attached to and mailed with a magazine or periodical.

The printed brochure is assembled, in step 626. The assembly of the brochure may include perforating, cutting, folding and collating the webs and/or sheets on which brochure information has been printed. The assembled brochure is attached, step 628, to the front or back cover of the periodical. The brochure and periodical assembly is mailed to the subscriber.

The invention has been described in connection with what is presently considered to be the most practical and preferred embodiment. The invention is not to be limited to the disclosed embodiment. It covers the various modifications and equivalent arrangements included within the spirit and scope of the appended claims.

What is claimed is:

1. A method comprising the steps of:
a. creating a first brochure version template and a second brochure version template, wherein each template has a variable print field;
b. accessing a subscriber list of subscribers to the periodical;
c. establishing a sorting criteria for sorting the subscriber list into sub-lists;
d. generating a first sub-list of subscribers and a second sub-list of subscribers based on the sorting criteria;
e. printing a first brochure version for each subscriber in said first sub-list by calling up the first brochure version template and subscriber information corresponding to the variable print field, and printing the brochure using print information from the template and subscriber information, wherein each printed first brochure version includes personalized information unique to a subscriber included in the first sub-list and to whom the printed first brochure version is addressed;
f. printing a second brochure version for each subscriber in said second sub-list by calling up the second brochure version template and subscriber information corresponding to the variable print field, and printing the brochure using print information from the template and subscriber information, wherein each printed second brochure version includes personalized information unique to a subscriber included in the second sub-list and to whom the printed first brochure version is addressed;
g. attaching the first and second printed brochure versions to a respective copy of a periodical, and
h. sending each of the printed brochure versions with attached periodical to the subscriber to which the brochure is addressed.

2. A method as in claim 1 wherein the sorting criteria relates to a characteristic of subscribers.

3. A method as in claim 2 wherein the sorting criteria relates to subscriber fiscal credit.

4. A method as in claim 1 wherein at least 25% of the first and second printed brochure versions includes substantive editorial or public service information or both.

5. A method for targeting promotions to individual subscribers of a periodical comprising the steps of:
a. selecting at least one sorting criteria to classify each of the subscribers;
b. accessing a first database having information regarding subscribers, and accessing at least a second database having information on individuals that is related to the sorting criteria;
C. sorting subscribers into a first sub-group or a second sub-group by applying the sorting criteria to the first database and the at least second database;
d. printing a first brochure version for each of the subscribers listed in said first sub-group, wherein each printed first brochure version includes information targeted to subscribers in the first sub-group and personalized information unique to the subscriber to whom the printed first brochure version is addressed;
f. printing a second brochure version for each of the subscribers listed in said first sub-group, wherein each printed second brochure version includes information targeted to subscribers in the second sub-group and personalized information unique to the subscriber to whom the printed second brochure version is addressed;
g. attaching the first and second printed brochure versions to respective copies of the periodical, and
h. sending each of the printed brochure versions with the attached periodical to the subscriber to which the brochure is addressed.

6. A method as in claim 5 wherein the sorting criteria relates to a characteristic of the subscribers.

7. A method as in claim 7 wherein the sorting criteria relates to subscriber fiscal credit.

8. A method as in claim 5 wherein at least 25% of the first and second printed brochure versions includes substantive editorial or public service information or both.

9. A method for targeting a financial product or service promotion to subscribers of a periodical comprising the steps of:
a. selecting at least one qualifying criteria to sort the subscribers, where the qualifying criteria relates to credit history;
b. for each subscriber, accessing a database of credit histories and determining whether the credit history of the subscriber satisfies the qualifying criteria;
c. assigning subscribers that satisfy the qualifying criteria to a first group and assigning other subscribers to a second group.
d. printing a first brochure version for each subscriber in said first group, wherein each printed first brochure version includes a pre-approved activation coupon for the product or service, and the coupon includes personalized information unique to the subscriber to whom the printed first brochure version is addressed;
f. printing a second brochure version for each subscriber listed in said second group, wherein each printed second brochure version includes an application for the financial product or service, which application has not been pre-approved, and said second brochure version includes personalized information unique to the subscriber to whom the printed second brochure version is addressed;
g. attaching the first and second printed brochure versions to respective copies of the periodical, and
h. sending each of the printed brochure versions with the attached periodical to the subscriber to whom the brochure is addressed.

10. A method as in claim 9 further comprising the step of sorting subscribers who currently have the financial product or service prior to step (b) from those subscribers to be the subject of steps (b) to (f).

11. A method as in claim 10 further comprising the steps of:
i. printing a third brochure version for each subscriber currently having the financial product or service, wherein each printed third brochure version includes coupons to promote the use of the product or service, and said third brochure version includes personalized information unique to the subscriber to whom the printed second brochure version is addressed;
g. attaching the third brochure versions to respective copies of the periodical, and proceeding to step (h).
